(19) United States
(12) Patent Application Publication
(10) Pub. No.: US 2026/0128232 A1
(43) Pub. Date: May 7, 2026

(54) CAPACITOR ARRAY

(71) Applicant: REALTEK SEMICONDUCTOR CORPORATION, HSINCHU (TW)

(72) Inventors: MIN-YUAN WU, HSINCHU (TW); YAN-TING WU, HSINCHU (TW)

(21) Appl. No.: 19/376,418

(22) Filed: Oct. 31, 2025

(30) Foreign Application Priority Data
Nov. 6, 2024 (TW) 113142504

(51) Int. Cl. H01G 4/38; H01G 4/228; H01G 4/30; H01G 4/40

(52) U.S. Cl. CPC H01G 4/38; H01G 4/228; H01G 4/30; H01G 4/40

(57) ABSTRACT

A capacitor array includes a first bottom plate, at least one top plate, at least one strip-shaped bottom plate, a first via, a second bottom plate, and a second via. The at least one top plate is disposed above the first bottom plate. The at least one strip-shaped bottom plate is disposed above the first bottom plate, and disposed outside the at least one top plate. The first via connects the first bottom plate to the at least one strip-shaped bottom plate. The second bottom plate is disposed above the at least one top plate and the at least one strip-shaped bottom plate. The second via connects the at least one bottom plate to the second bottom plate.

### BACKGROUND OF THE INVENTION

### 1. Field of the Invention

The present disclosure relates to a capacitor array, especially to a capacitor array capable of reducing the influence of noise.

### 2. Description of Related Art

A capacitor array can be applied in an analog to digital converter (ADC). The capacitor array includes a top plate and a bottom plate. In the industry, the top plate is typically placed on the outer side, and the bottom plate is placed on the inner side. However, the top plate is more sensitive. If the top plate is placed on the outer side, the capacitor array will be easily affected by noise.

### SUMMARY OF THE INVENTION

In some aspects, an object of the present disclosure is to, but not limited to, provides a capacitor array that makes an improvement to the prior art.

An embodiment of the capacitor array of the present disclosure includes a first bottom plate, at least one top plate, at least one strip-shaped bottom plate, a first via, a second bottom plate, and a second via. The at least one top plate is disposed above the first bottom plate. The at least one strip-shaped bottom plate is disposed above the first bottom plate, and disposed outside the at least one top plate. The first via connects the first bottom plate to the at least one strip-shaped bottom plate. The second bottom plate is disposed above the at least one top plate and the at least one strip-shaped bottom plate. The second via connects the at least one bottom plate to the second bottom plate.

Technical features of some embodiments of the present disclosure make an improvement to the prior art. In the capacitor array of the present disclosure, the top plate is disposed on the inner side, thereby reducing the influence of noise on the top plate. Specifically, the top plate of the capacitor array of the present disclosure is surrounded by the bottom plate in the X-axis, Y-axis, and Z-axis directions. Therefore, the top plate of the capacitor array of the present disclosure is not only interference-resistant in the X-axis and Y-axis directions, but also additionally interference-resistant in the Z-axis direction, thereby achieving an improved three-dimensional interference-resistant capability.

These and other objectives of the present invention will no doubt become obvious to those of ordinary skill in the art after reading the following detailed description of the preferred embodiments that are illustrated in the various figures and drawings.

### BRIEF DESCRIPTION OF THE DRAWINGS

FIG. 1 shows an embodiment of a comparator and a capacitor array of an analog to digital conversion circuit of the present disclosure.

FIG. 2 shows an embodiment of a partial structure of a capacitor array of the present disclosure.

FIG. 3 shows an embodiment of a partial structure of a capacitor array of the present disclosure.

FIG. 4 shows an embodiment of a partial structure of a capacitor array of the present disclosure.

FIG. 5 shows an embodiment of a partial structure of a capacitor array of the present disclosure.

FIG. 6 shows an embodiment of a partial structure of a capacitor array of the present disclosure.

FIG. 7 shows an embodiment of a partial structure of a capacitor array of the present disclosure.

FIG. 8 shows an embodiment of a cross-sectional view of a capacitor array of the present disclosure.

FIG. 9 shows an embodiment of a cross-sectional view of a capacitor array of the present disclosure.

### DETAILED DESCRIPTION OF THE PREFERRED EMBODIMENTS

To address the issue in the prior art in which the top plate of the capacitor array is easily affected by noise, the present disclosure provides a capacitor array, which will be described in detail as shown below.

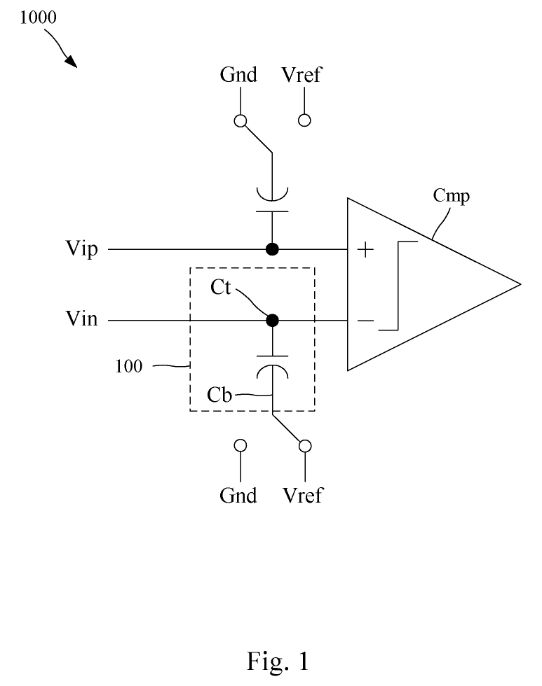

FIG. 1 shows an embodiment of a comparator Cmp and a capacitor array 100 of an analog to digital conversion circuit 1000 of the present disclosure. As shown in the figure, a node between the inverting input terminal of the comparator Cmp and one terminal of the capacitor array 100 is defined as a top plate node Ct, and the other terminal of the capacitor array 100 is defined as a bottom plate node Cb.

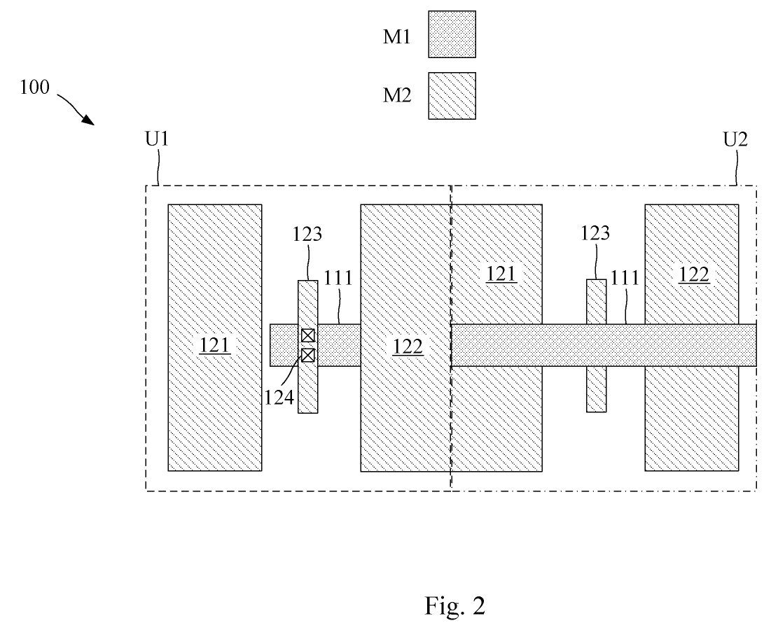

FIGS. 2 to 7 show embodiments of partial structures of the capacitor array 100 of the present disclosure. As shown in the figure, unit U1 is a unit of the capacitor array 100, and the unit U1 represents a top view of the capacitor array 100. In addition, the unit U2 is another unit of the capacitor array 100, and the unit U2 represents a bottom view of the capacitor array 100. FIGS. 2 to 7 illustrate the overall structure of the present disclosure in detail by means of the top view unit U1 and the bottom view unit U2 of the capacitor array 100.

Please refer to FIG. 2. The capacitor array 100 includes a connection plate 111, ground plates 121, 122, a connection plate 123, and a via 124. The connection plate 111 is connected to the bottom plate node Cb in FIG. 1. The ground plates 121, 122 and the connection plate 123 are disposed above the connection plate 111, and the ground plates 121, 122 are disposed outside the connection plate 123. The ground plates 121, 122 are connected to a ground point (e.g., ground). The via 124 connects the connection plate 123 to the connection plate 111.

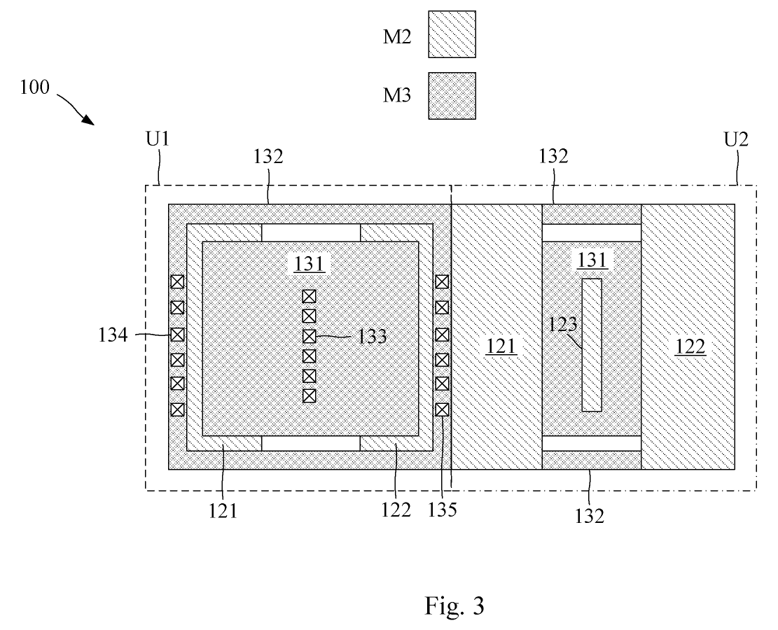

Please refer to FIG. 3. The capacitor array 100 further includes a bottom plate 131, a ground plate 132, and vias 133, 134, 135. The bottom plate 131 is disposed above the ground plates 121, 122 and the connection plate 123, and is located at the center of the unit U1. The ground plate 132 is disposed above the ground plates 121, 122 and the connection plate 123, and is located outside the bottom plate 131. For example, the ground plate 132 is disposed around the bottom plate 131. The ground plate 132 of the capacitor array 100 of the present disclosure can serve as a ground shielding to prevent the capacitor array 100 from being affected by surrounding interference. The via 133 connects the bottom plate 131 to the connection plate 123. The via 134 connects the ground plate 132 to the ground plate 121. The via 135 connects the ground plate 132 to the ground plate 122.

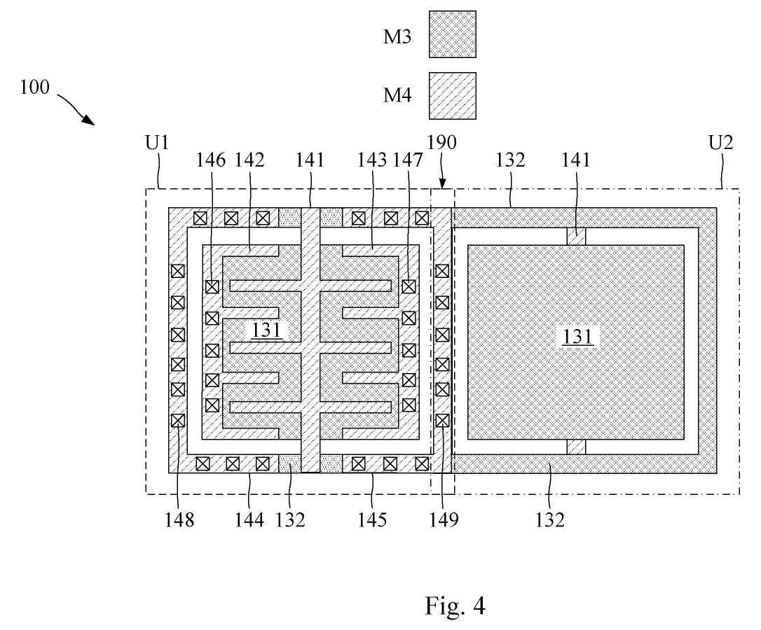

Please refer to FIG. 4. The capacitor array 100 further includes a top plate 141, strip-shaped bottom plates 142, 143, ground plates 144, 145, and vias 146, 147, 148, 149. The top plate 141 is connected to the top plate node Ct in FIG. 1. The top plate 141 is disposed above the bottom plate 131 and the ground plate 132. The strip-shaped bottom plates 142, 143 are disposed above the bottom plate 131, and located outside the top plate 141. For example, the strip-shaped bottom plates 142, 143 are disposed around the top plate 141. The via 146 connects the bottom plate 131 to the strip-shaped bottom plate 142. The via 147 connects the bottom plate 131 to the strip-shaped bottom plate 143. The ground plates 144, 145 are disposed above the ground plate 132, and located outside the top plate 141 and the strip-shaped bottom plates 142, 143. For example, the ground plates 144, 145 are disposed around the top plate 141 and the strip-shaped bottom plates 142, 143. The via 148 connects the ground plate 144 to the ground plate 132. The via 149 connects the ground plate 145 to the ground plate 132. It should be noted that some structures of the unit U1 and the unit U2 of the capacitor array 100 overlap, such as at reference number 190, where the unit U1 and unit U2 may share a grounding structure. In addition, since the capacitor array 100 of the present disclosure includes an entire bottom plate 131, the bottom plate 131 can block the parasitic coupling from the top plate 141 to a lower substrate (not shown). Since the parasitic coupling is reduced, the dynamic range of the analog-to-digital conversion circuit 1000 in FIG. 1 can be correspondingly reduced.

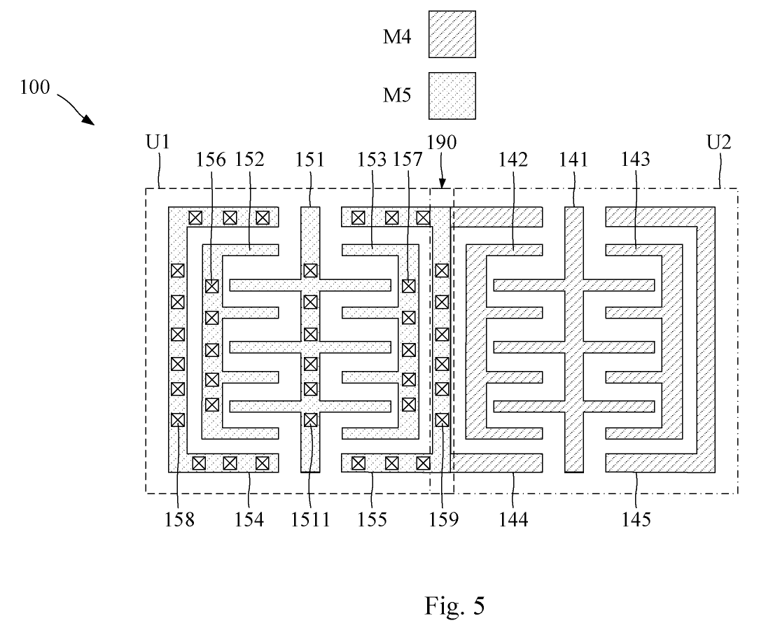

Please refer to FIG. 5. The capacitor array 100 further includes a top plate 151, strip-shaped bottom plates 152, 153, ground plates 154, 155, and vias 156, 157, 158, 159, 1511. The top plate 151 is disposed above the top plate 141. The strip-shaped bottom plates 152, 153 are disposed above the strip-shaped bottom plates 142, 143, and located outside the top plate 151. For example, the strip-shaped bottom plates 152, 153 are disposed around the top plate 151. The via 1511 connects the top plate 151 to the top plate 141. The via 156 connects the strip-shaped bottom plate 152 to the strip-shaped bottom plate 142. The via 157 connects the strip-shaped bottom plate 153 to the strip-shaped bottom plate 143. The ground plates 154, 155 are disposed above the ground plates 144, 145, and located outside the top plate 151 and the strip-shaped bottom plates 152, 153. For example, the ground plates 154, 155 are disposed around the top plate 151 and the strip-shaped bottom plates 152, 153. The via 158 connects the ground plate 154 to the ground plate 144. The via 159 connects the ground plate 155 to the ground plate 145. It should be noted that some structures of the unit U1 and unit U2 of the capacitor array 100 overlap, such as at reference number 190, where the units U1 and U2 may share a grounding structure.

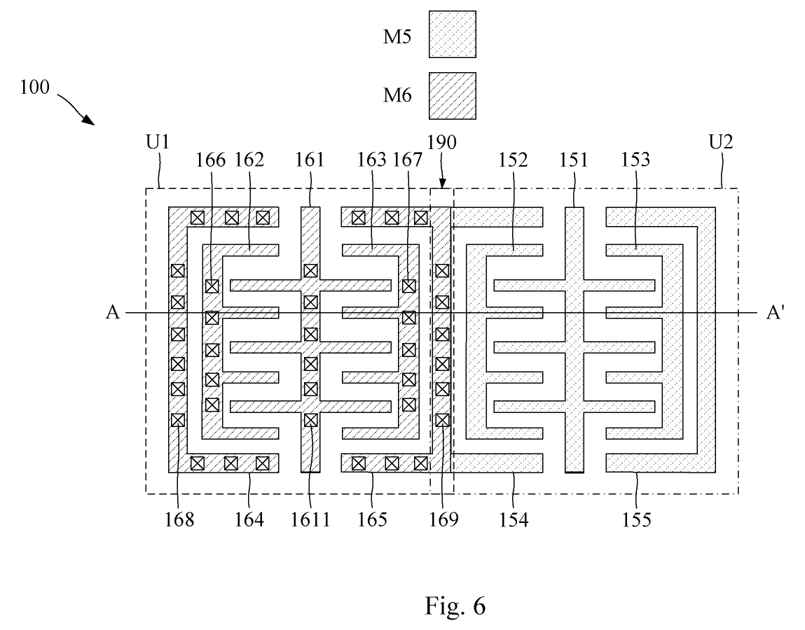

Please refer to FIG. 6. The capacitor array 100 further includes a top plate 161, strip-shaped bottom plates 162, 163, ground plates 164, 165, and vias 166, 167, 168, 169, 1611. The top plate 161 is disposed above the top plate 151. The strip-shaped bottom plates 162, 163 are disposed above the strip-shaped bottom plates 152, 153, and located outside the top plate 161. For example, the strip-shaped bottom plates 162, 163 are disposed around the top plate 161. The via 1611 connects the top plate 161 to the top plate 151. The via 166 connects the strip-shaped bottom plate 162 to the strip-shaped bottom plate 152. The via 167 connects the strip-shaped bottom plate 163 to the strip-shaped bottom plate 153. The ground plates 164, 165 are disposed above the ground plates 154, 155, and located outside the top plate 161 and the strip-shaped bottom plates 162, 163. For example, the ground plates 164, 165 are disposed around the top plate 161 and the strip-shaped bottom plates 162, 163. The via 168 connects the ground plate 164 to the ground plate 154. The via 169 connects the ground plate 165 to the ground plate 155. It should be noted that some structures of the unit U1 and unit U2 of the capacitor array 100 overlap, such as at reference number 190, where the units U1 and U2 may share a grounding structure.

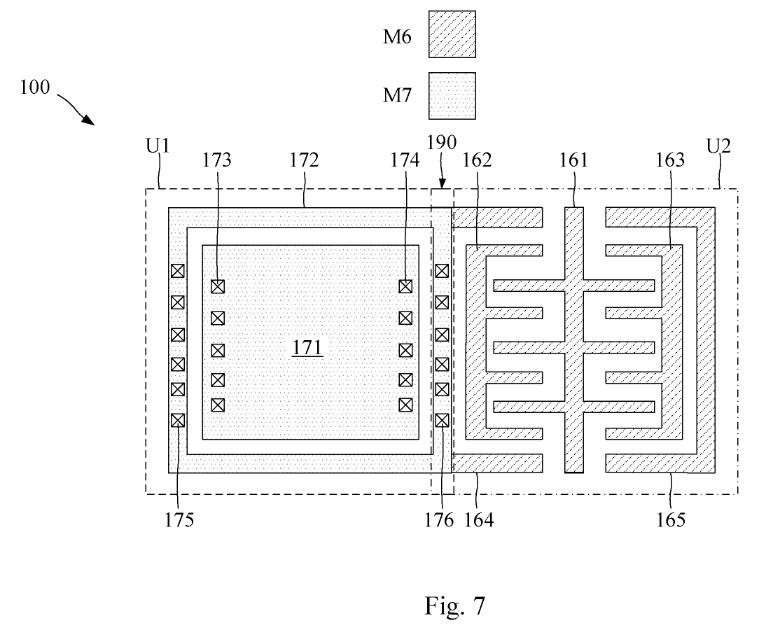

Please refer to FIG. 7. The capacitor array 100 further includes a bottom plate 171, a ground plate 172, and vias 173, 174, 175, 176. The bottom plate 171 is disposed above the top plate 161 and the strip-shaped bottom plates 162, 163, and located at the center of the unit U1. The ground plate 172 is disposed above the ground plates 164, 165, and located outside the bottom plate 171. For example, the ground plate 172 is disposed around the bottom plate 171. The via 173 connects the bottom plate 171 to the strip-shaped bottom plate 162. The via 174 connects the bottom plate 171 to the strip-shaped bottom plate 163. The via 175 connects the ground plate 172 to the ground plate 164. The via 176 connects the ground plate 172 to the ground plate 165. It should be noted that some structures of the unit U1 and unit U2 of the capacitor array 100 overlap, such as at reference number 190, where the units U1 and U2 may share a grounding structure.

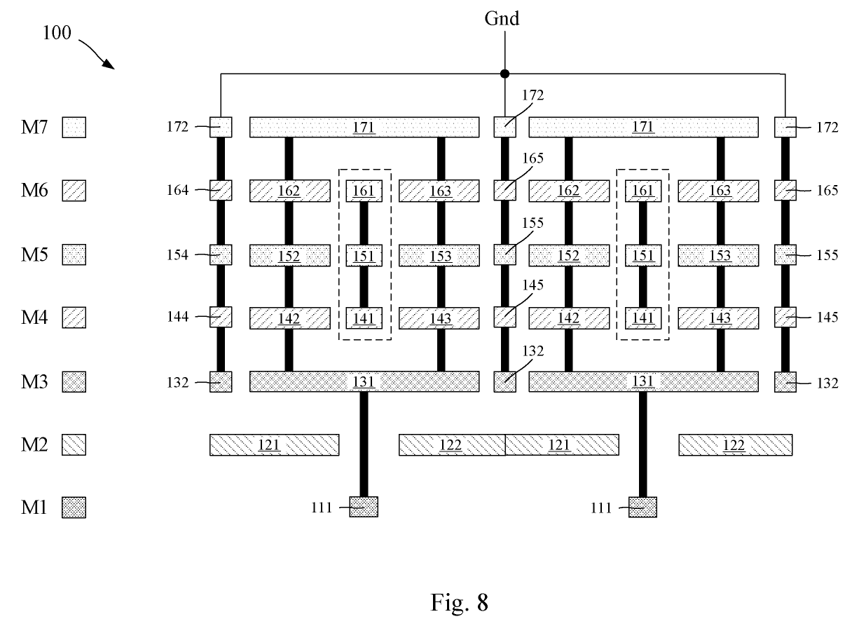

FIG. 8 shows an embodiment of a cross-sectional view taken along the AA' line of the capacitor array 100 in FIG. 6 of the present disclosure. As shown on the left side of FIG. 8, the capacitor array 100 of the present disclosure includes metal layers M1~M7. The structures of the capacitor array 100 of the present disclosure are respectively disposed on the corresponding metal layers M1~M7. As shown on the right side of FIG. 8, the top plates 141, 151, 161 are disposed on the inner side of the capacitor array 100. The bottom plates 131, 171, and the strip-shaped bottom plates 142, 143, 152, 153, 162, 163 are disposed around the top plates 141, 151, 161. In other words, the top plates 141, 151, 161 are enclosed within the bottom plates 131, 137 and the strip-shaped bottom plates 142, 143, 152, 153, 162, 163, which reduces the influence of noise on the top plates 141, 151, 161. Specifically, the top plates 141, 151, 161 of the capacitor array 100 of the present disclosure are surrounded by bottom plates in the X-axis, Y-axis, and Z-axis directions. Therefore, the top plates 141, 151, 161 of the capacitor array 100 of the present disclosure are interference-resistant not only in the X-axis and Y-axis directions, but also additionally interference-resistant in the Z-axis direction, thereby achieving an improved three-dimensional interference-resistant capability.

It should be noted that FIG. 8 merely illustrates one possible implementation of the capacitor array 100. The present disclosure is not limited to the structure in FIG. 8. In some embodiments, the capacitor array 100 of the present disclosure may include only a single top plate (e.g., one of top plates 141, 151, 161). In addition, the capacitor array 100 of the present disclosure may include strip-shaped bottom plates formed in a single layer, which are disposed around the single top plate. Furthermore, the capacitor array 100 of the present disclosure may include two bottom plates (e.g., bottom plates 131, 171), and the two bottom plates are disposed above and below the single top plate, respectively, to protect the single top plate within the inner side of the capacitor array 100. As such, the capacitor array 100 of the present disclosure can reduce the influence of noise on the top plate.

In some embodiments, the capacitor array 100 of the present disclosure may include only a single top plate (e.g., one of top plates 141, 151, 161). In another embodiment, the capacitor array 100 of the present disclosure may include two top plates 141, 151. In still another embodiment, the capacitor array 100 of the present disclosure may include three top plates 141, 151, 161. Alternatively, the capacitor array 100 of the present disclosure may include more than three top plates. The actual number of top plates may be determined based on the actual requirements of the capacitor array 100 of the present disclosure.

In some embodiments, the capacitor array 100 of the present disclosure may include strip-shaped bottom plates 142, 143 formed in a single layer. In another embodiment, the capacitor array 100 of the present disclosure may include strip-shaped bottom plates 142, 143, 152, 153 formed in two layers. In still another embodiment, the capacitor array 100 of the present disclosure may include strip-shaped bottom plates 142, 143, 152, 153, 162, 163 formed in three layers. Alternatively, the capacitor array 100 of the present disclosure may include strip-shaped bottom plates formed in more than three layers. The actual number of layers related to strip-shaped bottom plates may be determined based on the actual requirements of the capacitor array 100 of the present disclosure.

In some embodiments, referring to the metal layer M4, strip-shaped bottom plates formed in a single layer includes a first strip-shaped sub-bottom plate 142 and a second strip-shaped sub-bottom plate 143. The first strip-shaped sub-bottom plate 142 is disposed on the left side of the top plate 141, and the second strip-shaped sub-bottom plate 143 is disposed on the right side of the top plate 141, wherein the left side is opposite to the right side. Furthermore, the capacitor array 100 of the present disclosure includes a first sub-ground plate 144 and a second sub-ground plate 145 disposed on the same metal layer M4. The first sub-ground plate 144 is disposed outside the first strip-shaped sub-bottom plate 142. The second sub-ground plate 145 is disposed outside the second strip-shaped sub-bottom plate 143.

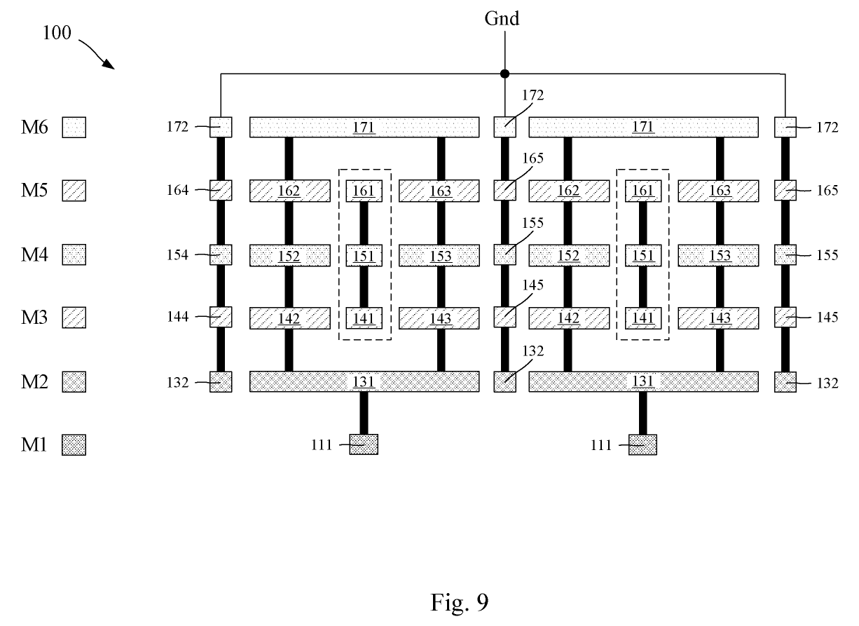

FIG. 9 shows an embodiment of a cross-sectional view of a capacitor array 100 of the present disclosure. Compared with FIG. 8, the capacitor array 100 in FIG. 9 does not need the metal layer M2 in FIG. 8. Nevertheless, the capacitor array 100 in FIG. 9 can also protect the top plates 141, 151, 161 within the inner side of the capacitor array 100, thereby achieving the purpose of reducing the influence of noise on the top plates 141, 151, 161. Specifically, the top plates 141, 151, 161 of the capacitor array of the present disclosure are surrounded by bottom plates in the X-axis, Y-axis, and Z-axis directions. Therefore, the top plates 141, 151, 161 of the capacitor array of the present disclosure are interference-resistant not only in the X-axis and Y-axis directions, but also additionally interference-resistant in the Z-axis direction, thereby achieving an improved three-dimensional interference-resistant capability. Moreover, since the capacitor array 100 in FIG. 9 can reduce one metal layer, the manufacturing cost of the capacitor array 100 can be further reduced.

It is noted that the present disclosure is not limited to the embodiments as shown in FIG. 1 to FIG. 9, they are merely examples for illustrating one of the implements of the present disclosure, and the scope of the present disclosure shall be defined on the basis of the claims as shown below. In view of the foregoing, it is intended that the present disclosure covers modifications and variations to the embodiments of the present disclosure, and modifications and variations to the embodiments of the present disclosure also fall within the scope of the following claims and their equivalents.

As described above, technical features of some embodiments of the present disclosure make an improvement to the prior art. The capacitor array of the present disclosure places the top plate on the inner side, thereby reducing the influence of noise on the top plate. Specifically, the top plate of the capacitor array of the present disclosure is surrounded by bottom plates in the X-axis, Y-axis, and Z-axis directions. Therefore, the top plate of the capacitor array of the present disclosure is not only interference-resistant in the X-axis and Y-axis directions, but also additionally interference-resistant in the Z-axis direction, thereby achieving an improved three-dimensional interference-resistant capability.

It is noted that people having ordinary skill in the art can selectively use some or all of the features of any embodiment in this specification or selectively use some or all of the features of multiple embodiments in this specification to implement the present invention as long as such implementation is practicable; in other words, the way to implement the present invention can be flexible based on the present disclosure.

The aforementioned descriptions represent merely the preferred embodiments of the present invention, without any intention to limit the scope of the present invention thereto. Various equivalent changes, alterations, or modifications based on the claims of the present invention are all consequently viewed as being embraced by the scope of the present invention.

What is claimed is:

1. A capacitor array, comprising:
a first bottom plate;
at least one top plate, disposed above the first bottom plate;
at least one strip-shaped bottom plate, disposed above the first bottom plate, and disposed outside the at least one top plate;
a first via, connected the first bottom plate to the at least one strip-shaped bottom plate;
a second bottom plate, disposed above the at least one top plate and the at least one strip-shaped bottom plate; and
a second via, connected the at least one strip-shaped bottom plate to the second bottom plate.

2. The capacitor array of claim 1, wherein the at least one top plate comprises:
a first top plate, disposed above the first bottom plate; and
a second top plate, disposed above the first top plate.

3. The capacitor array of claim 2, wherein the at least one strip-shaped bottom plate comprises:
a first strip-shaped bottom plate, disposed above the first bottom plate, and disposed around the first top plate; and
a second strip-shaped bottom plate, disposed above the first strip-shaped bottom plate, and disposed around the second top plate.

4. The capacitor array of claim 3, further comprising:
a third via, connected the first top plate to the second top plate; and
a fourth via, connected the first strip-shaped bottom plate to the second strip-shaped bottom plate.

5. The capacitor array of claim 4, wherein the at least one top plate further comprises:
a third top plate, disposed above the second top plate;
wherein the at least one strip-shaped bottom plate further comprises:
a third strip-shaped bottom plate, disposed above the second strip-shaped bottom plate, and disposed around the third top plate.

6. The capacitor array of claim 5, further comprising:
a fifth via, connected the second top plate to the third top plate; and
a sixth via, connected the second strip-shaped bottom plate to the third strip-shaped bottom plate.

7. The capacitor array of claim 1, further comprising:
at least one ground plate, disposed outside the at least one top plate and the at least one strip-shaped bottom plate.

8. The capacitor array of claim 7, wherein the at least one ground plate comprises:
a first ground plate, disposed around the first bottom plate;
a second ground plate, disposed above the first ground plate, and disposed around the at least one top plate and the at least one strip-shaped bottom plate; and
a third ground plate, disposed above the second ground plate, and disposed around the second bottom plate.

9. The capacitor array of claim 1, wherein the at least one strip-shaped bottom plate comprises:
a first strip-shaped sub-bottom plate, disposed on a first side of the at least one top plate; and
a second strip-shaped sub-bottom plate, disposed on a second side of the at least one top plate, wherein the first side is opposite to the second side.

10. The capacitor array of claim 9, further comprising:
a first sub-ground plate, disposed outside the first strip-shaped sub-bottom plate; and
a second sub-ground plate, disposed outside the second strip-shaped sub-bottom plate.
